(19) United States
(12) Patent Application Publication
(10) Pub. No.: US 2013/0320768 A1
(43) Pub. Date: Dec. 5, 2013

(54) ELECTRIC STORAGE DEVICE SYSTEM AND COMMUNICATION METHOD IN THE ELECTRIC STORAGE DEVICE SYSTEM

(71) Applicant: GS Yuasa International Ltd., Kyoto-shi (JP)

(72) Inventors: Masakatsu Fujimatsu, Kyoto-shi (JP); Eiji Hayashi, Kyoto-shi (JP)

(73) Assignee: GS Yuasa International Ltd., Kyoto-shi (JP)

(21) Appl. No.: 13/903,871

(22) Filed: May 28, 2013

(30) Foreign Application Priority Data
May 30, 2012 (JP) 2012-123368

(51) Int. Cl. H02J 1/00

(52) U.S. Cl. CPC H02J 1/00
USPC 307/77

(57) ABSTRACT

An electric storage device system includes an electric storage device module including at least one electric storage device, a communication path, a capacitor connected to the electric storage device module at one end thereof and connected to the communication path at another end thereof, and an electric storage device monitor. The capacitor and at least a part of the electric storage device module configure a current path. The electric storage device monitor is configured to communicate by using the communication path and the current path.

### CROSS-REFERENCE TO RELATED APPLICATION

This application claims the benefit of Japanese patent application No. 2012-123368 filed on May 30, 2012, which is incorporated herein by reference.

### FIELD

The present invention relates to an electric storage device system and a communication method in the electric storage device system, in particular to a communication wiring technology used in communication for monitoring the electric storage device.

### BACKGROUND

Conventionally, a hybrid vehicle and an electric vehicle include a large number of battery cells (electric storage devices). A group of battery cells is referred to as a battery module (an electric storage device module). A group of battery modules is referred to as a battery pack. The battery module may be referred to as an assembled battery. A battery cell monitor may be provided for each battery module (each assembled battery) to monitor each battery cell. The battery cell monitor obtains data such as a cell voltage, and the data is transmitted to a battery management unit. The battery management unit controls the battery packs based on the data. The data of the battery such as the cell voltage is transmitted through the battery cells that are necessary as a signal path for the control. Patent Document 1, for example, discloses a communication wiring technology used in such a communication. Specifically, the technology disclosed in Patent Document 1 uses a power supply line, i.e., a charge-discharge path of the battery cell, to establish communication between a controller (a battery management unit) and a detector (a cell monitor).

Patent Document 1: JP-A-2010-203848

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In the technology described in Patent Document 1, battery cells are arranged between the controller and the detector. In such a configuration, the communication may be affected by the position of the detector. For example, the number of battery cells between the controller and the detector may be varied depending on the position of the detector. Therefore, communication signal loss increases as the number of battery cells between the controller and the detector increases, i.e., as impedance of the battery cell increases.

The present invention was accomplished in view of the above circumstances. An object of the present invention is to provide a technology that establishes a communication in the electric storage device system via an electric storage device without having any adverse effect of impedance of the electric storage device.

An electric storage device system disclosed herein includes an electric storage device module including at least one electric storage device, a communication path, a capacitor, and an electric storage device monitor. The capacitor is connected to the electric storage device module at one end thereof and connected to the communication path at another end thereof. The capacitor and at least a part of the electric storage device module configure a current path. The electric storage device monitor is configured to communicate by using the communication path and the current path.

### BRIEF DESCRIPTION OF DRAWINGS

The foregoing and other features of the present invention will become apparent from the following description and drawings of an illustrative embodiment of the invention in which:

FIG. 1 is a block diagram schematically illustrating an electrical configuration of a battery system according to an embodiment;

FIG. 2 is a schematic block diagram for explaining communication between battery cell monitors;

FIG. 3 is an equivalent circuit for explaining communication between the battery cell monitors; and

FIG. 4 is a graph illustrating an example of a communication signal waveform.

### DESCRIPTION OF EMBODIMENTS

An electric storage device system disclosed herein includes an electric storage device module including at least one electric storage device, a communication path, a capacitor, and an electric storage device monitor. The capacitor is connected to the electric storage device module at one end thereof and connected to the communication path at another end thereof. The capacitor and at least a part of the electric storage device module configure a current path. The electric storage device monitor is configured to communicate by using the communication path and the current path.

In this configuration, a normal communication can be established even when impedance is present in the electric storage device, because a voltage drop is small due to the capacitor that is connected to the electric storage device module at its one end. Namely, the presence of the electric storage devices in the communication path has no adverse effect. Accordingly, in the electric storage device system, the communication via the electric storage device can be established without being adversely affected by the impedance of the electric storage devices.

Further, the communication path that is connected to the current path via the capacitor is provided such that communication between the electric storage device monitors is established by using the communication path and the current path. Accordingly, the number of the communication paths and the coupling capacitors is reduced, and thus the configuration relating to the communication paths provided for communication between the electric storage device monitors can be simplified.

The electric storage device system may further include an electric storage device management unit configured to manage the electric storage device monitor by using the communication path and the current path.

This configuration can simplify the configuration relating to the communication paths for communication between the electric storage device monitor and the electric device management unit.

In the above-described electric storage device system, the electric storage device monitor may include a coupling capacitor connected to the communication path. Each of the coupling capacitor and the capacitor may have a capacitance that satisfies a following relationship: Zcc<Zct and Zmod<Zct where Zmod, Zcc, and Zct indicate impedance of the electric storage device module, impedance of the coupling capacitor, and impedance of the capacitor, respectively, at a frequency of a communication signal transmitted through the communication path and the current path.

With this configuration, effects of the impedance of the electric storage device module can be properly reduced, and a level of the communication signal is less likely to decrease.

A communication signal transmitted through the communication path and the current path is set to have an amplitude substantially equal to a voltage of the electric storage device module.

With this configuration, the communication signal can have increased noise tolerance by increasing the amplitude of the communication signal.

A communication method in an electric storage device system disclosed herein is a communication method in an electric storage device system including an electric storage device module and an electric storage device monitor configured to monitor the electric storage device module. The electric storage device module includes at least one electric storage device and configures a current path. The communication method includes providing a capacitor so as to be connected to one end of the electric storage device module, providing a communication path so as to be connected to another end of the electric storage device module, and connecting the electric storage device monitor to the communication path. The electric storage device monitor establishes communication by using the communication path and the current path.

In the communication method in the electric storage device system, the electric storage device system may further include an electric storage device management unit. The electric storage device management unit may be configured to manage the electric storage device by using the communication path and the current path.

In the communication method in the electric storage device system, the electric storage device monitor may further include a coupling capacitor. The coupling capacitor may be connected to the communication path. Each of the coupling capacitor and the capacitor may have a capacitance that satisfies a following relationship: Zcc<Zct and Zmod<Zct where Zmod, Zcc, and Zct indicate impedance of the electric storage device module, the coupling capacitor, and the capacitor, respectively, at a frequency of a communication signal transmitted through the communication path and the current path.

The communication method in the electric storage device system may further include setting an amplitude of a communication signal transmitted through the communication path and the current path so as to be substantially equal to a voltage of the electric storage device module.

According to the present invention, due to the impedance of the capacitor that is connected to the electric storage device module at its one end, communication via the electric storage device can be established without being adversely affected by impedance of the electric storage device.

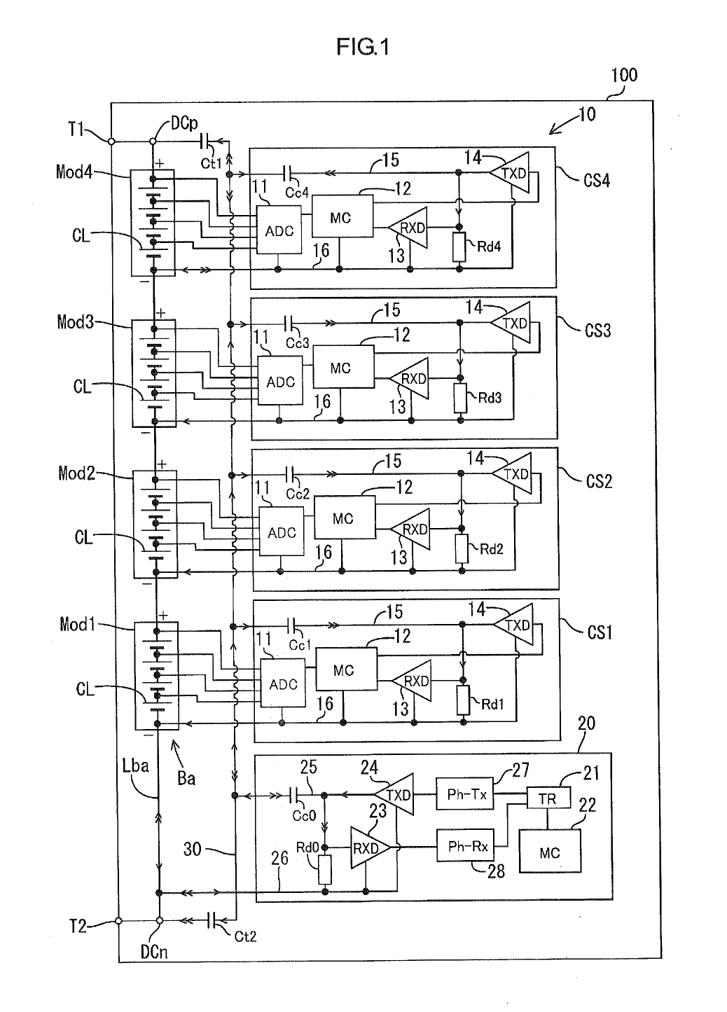

An embodiment of a battery system according to the present invention will be described with reference to FIG. 1 to FIG. 4.

### 1. Configuration of the Battery System

FIG. 1 is a block diagram schematically illustrating an electrical configuration of a battery system 100 (an example of an electric storage device system) according to the present embodiment. The battery system 100 may be mounted in a vehicle such as a hybrid vehicle and an electric vehicle. The battery system 100 may not be necessarily mounted in a vehicle, but may be used in various applications as a direct-current power system.

The battery system 100 includes a plurality of (here, four) battery modules Mod1 to Mod4 (an example of an electric storage device module), a plurality of (here, four) battery cell monitors CS1 to CS4 (an example of an electric storage device monitor), a battery management unit 20 (an example of the electric storage device monitor), a common communication line 30 (an example of a communication path), a charge-discharge path Lba (an example of a current path), terminals T1 to T2, a first termination capacitor Ct1, and a second termination capacitor Ct2, for example. The battery modules Mod1 to Mod4 and the battery cell monitors CS1 to CS4 configure a battery pack 10.

Each of the battery modules Mod1 to Mod4 includes at least one (here, four) battery cell CL (an example of an electric storage device). The battery modules Mod1 to Mod4 are connected in series and configure one battery power Ba (corresponding to a “full cell”). In this embodiment, the battery cell CL is a lithium cell, which is a secondary cell, for example. The battery cell CL is not limited to the lithium cell, but may be a zinc cell or a primary cell. The number of battery cells included in each battery module may be one. That is, each of the battery modules Mod1 to Mod4 may be one battery cell CL.

The positive terminal T1 is connected to a positive electrode DCp of the battery power Ba. The negative terminal T2 is connected to a negative electrode DCn of the battery power Ba. The battery power Ba is charged or discharged through the positive terminal T1, the charge-discharge path Lba, and the negative terminal T2. In the present embodiment, the charge-discharge path Lba is a path extending from the positive terminal T1 to the negative terminal T2 through the battery modules Mod1 to Mod4. The charge-discharge path Lba includes the first termination capacitor Ct1, the second termination capacitor Ct2, and the battery modules Mod1 to Mod4. The charge-discharge path Lba is not limited to the configuration of present embodiment. The charge-discharge path Lba may include at least a part of the battery modules Mod1 to Mod4. For example, the charge-discharge path Lba may include the first termination capacitor Ct1 and the battery modules Mod2 to Mod4.

The first termination capacitor Ct1 is connected to the positive electrode DCp of the battery power Ba at its one end. The second termination capacitor Ct2 is connected to the negative electrode DCn of the battery power Ba at its one end. The common communication line 30 is connected to the other end of the first termination capacitor Ct1 and the other end of the second termination capacitor Ct2. That is, the common communication line 30 is connected in parallel with the charge-discharge path Lba via the first termination capacitor Ct1 and the second termination capacitor Ct2. The common communication line 30 is connected to each communication unit (13, 14, 23, 24) included in each of the battery cell monitors CS1 to CS4 and the battery management unit 20. One of the first termination capacitor Ct1 and the second termination capacitor Ct2 may not be provided when communication alone is considered. In such a case, the common communication line 30 has an open end to which the termination capacitor Ct is not connected. When noise or the like is also considered, both of the termination capacitors Ct1, Ct2 may be preferably provided like the present embodiment.

The first termination capacitor Ct1 and the second termination capacitor Ct2 are intended to provide galvanic isolation between the common communication line 30 and the battery power Ba and to prevent reflection of the communication signal. Further, the termination capacitors Ct1, Ct2 are intended to increase communication current flowing in the charge-discharge path Lba and the common communication line 30 and to improve tolerance for noise.

The first termination capacitor Ct1 and the second termination capacitor Ct2 are each an example of the “capacitor” of the present invention that is connected to the electric storage device module at one end thereof. The “capacitor” of the present invention is not limited to the first termination capacitor Ct1 and the second termination capacitor Ct2. The “capacitor” may be a capacitor that is provided between the charge-discharge path Lba that extends between the battery module Mod1 and the battery module Mod2 and the common communication line 30.

The battery cell monitors CS1 to CS4 are provided for the battery modules Mod1 to Mod4, respectively, to monitor a condition of each battery cell CL. Each of the battery cell monitors CS1 to CS4 includes an ADC (analog-digital converter) 11, a microcomputer 12, a receiver 13 (an example of a “communication unit”), a transmitter 14 (an example of a “communication unit”), a communication line 15, a feedback line 16, a coupling capacitor Cc, and a sense resistor Rd.

The ADC 11 is connected to each battery cell CL in the corresponding battery module Mod1 to Mod4. The ADC 11 receives analog signals such as voltages of the battery cells from the battery cells CL and converts the analog signals to digital signals. The digitalized signals such as digitalized voltage signals are supplied to the microcomputer 12. The microcomputer 12 includes a CPU and a memory, for example. The microcomputer 12 is configured to control each of the components in the battery cell monitor CS.

The sense resistor Rd included in each battery cell monitor CS1 to CS4 is configured to detect a communication signal transmitted from the battery cell monitors CS other than the one including the sense resistor Rd or from the battery monitor 20. The detected signal (voltage) is transmitted to the receiver 13 and supplied to the microcomputer 12.

The signal such as voltages of the battery cells CL detected by the ADC 11 is supplied to the microcomputer 12. Then, the detected signals are converted to predetermined communication signal (transmission signal) by the microcomputer 12 and supplied to the transmitter 14. The communication signal is transmitted from the transmitter 14 to the battery management unit 20 or another battery cell monitor CS through the communication line 15 and the common communication line 30. The microcomputer 12 receives the communication signals from the battery management unit 20 or another battery cell monitor CS through the common communication line 30, the communication line 50, and the receiver 13.

The communication line 15 is connected to the common communication line 30 via the coupling capacitor Cc. The coupling capacitor Cc provides galvanic isolation between the common communication line 30 and the inner side of the battery cell monitor CS. The feedback line 16 is connected to the negative electrode (−) of the battery module Mod. Although power supply lines for the battery cell monitors CS1 to CS4 are not illustrated in FIG. 1, the battery cells CL supply power to each of the battery cell monitors CS1 to CS4.

The battery management unit 20 includes a communication circuit 21, a microcomputer 22, a receiver 23, a transmitter 24, a communication line 25, a feedback line 26, an insulation element for transmitting 27, an insulation element for receiving 28, a coupling capacitor Cc0, and a sense detector Rd0, for example.

The battery management unit 20 is connected to the communication units 13, 14 of each battery cell monitor CS1 to CS4 via the communication line 30 and the charge-discharge path Lba to manage the battery cell monitors CS1 to CS4 and the battery cells CL.

The microcomputer 22 includes a CPU and a memory, for example, and manages and controls the cell voltage of each battery cell CL based on the cell voltage data from each battery cell monitor CS1 to CS4. Further, the microcomputer 22 assigns an ID to each of the battery cell monitors CS1 to CS4, for example.

The insulation element for transmitting 27 and the insulation element for receiving 28 provide insulation between each of the communication circuit 21 and the microcomputer 22 and the battery power Ba in electrical connection, i.e., insulate the communication circuit 21 and the microcomputer 22 of the battery management unit 20 from the battery power Ba. Each of the insulation element for transmitting 27 and the insulation element for receiving 28 is a photocoupler, for example. The communication circuit 21 functions as a communication interface between the battery cell monitors CS and the battery management unit 20.

### 2. Communication Path

Various communication paths corresponding to various communication configurations in the battery system 100 will be explained.

2-1. Communication from the Battery Management Unit to each Battery Cell Monitor

In the communication from the battery management unit 20 to each battery cell monitor CS1 to CS4, as indicated by single-headed arrows in FIG. 1, the communication signal is transmitted from the receiver 24 of the battery management unit 20 to the common communication line 30 via the coupling capacitor Cc0. The communication signal is transmitted from the common communication line 30 to the respective battery cell monitors CS1 to CS4 and detected by each sensor resistor Rd1 to Rd4 thereof, and then supplied to each microcomputer 12 through the respective receivers 13. As indicated by the single-headed arrows in FIG. 1, the communication signal supplied to each battery cell monitor CS1 to CS4 is returned to the battery management unit 20 via each feedback line 16, the charge-discharge path Lba, and the feedback line 26.

2-2. Communication from the Battery Cell Monitor to the Battery Management Unit

In the communication from each of the battery cell monitors CS1 to CS4 to the battery management unit 20, for example, in the communication from the battery cell monitor CS4 to the battery management unit 20, as indicated by two-headed arrows, a communication signal is transmitted from the receiver 14 of the battery cell monitor CS4 to the common communication line 30 via the coupling capacitor Cc4. Then, the communication signal is transmitted from the common communication line 30 to the sense resistor Rd0 through the coupling capacitor Cc0 of the battery management unit 20 and detected by the sense resistor Rd0. Subsequently, the communication signal is supplied to the microcomputer 22 through the receiver 23 and the insulation element for receiving 28, for example. As indicated by the two-headed arrows in FIG. 1, the communication signal supplied to the battery management unit 20 is returned to the battery cell monitor CS4 through the feedback line 26, the charge-discharge path Lba, and the feedback line 16.

2-3. Communication between the Battery Cell Monitors

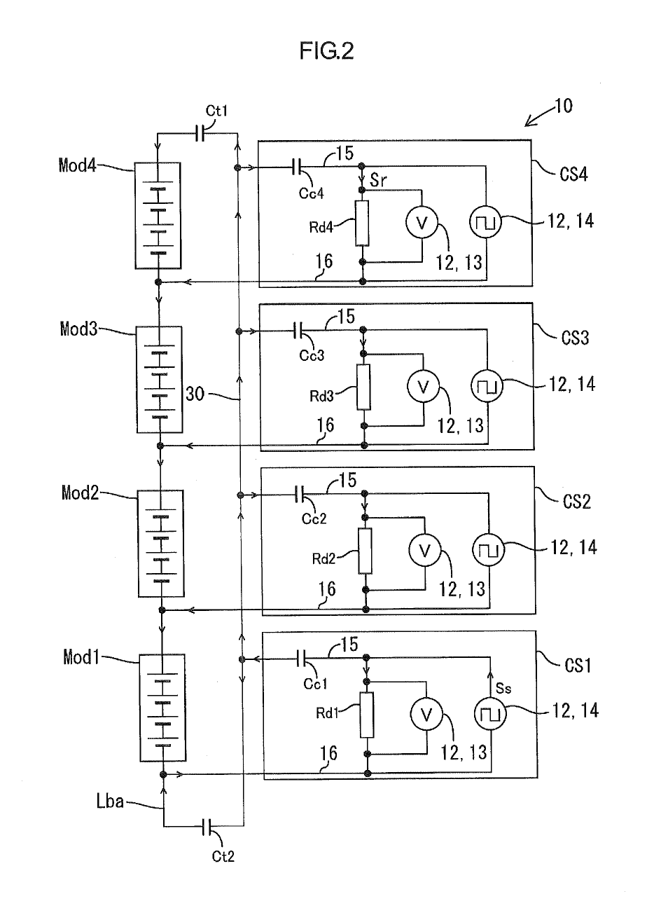

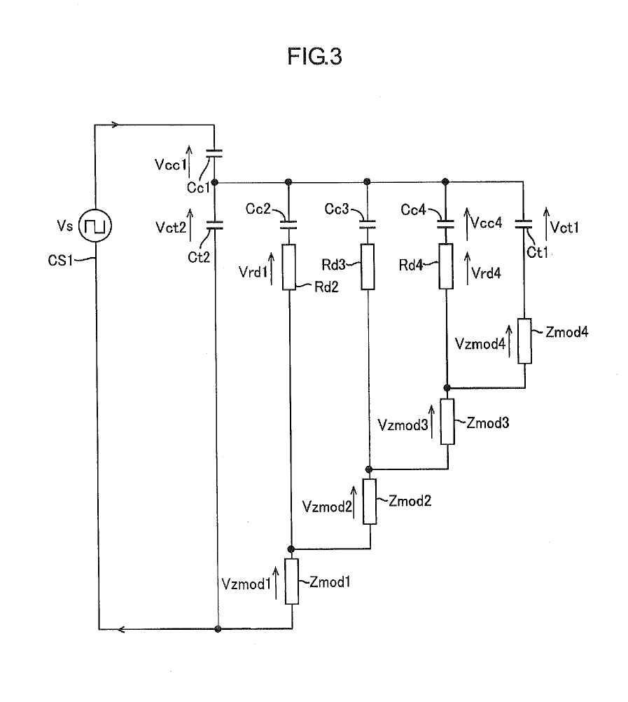

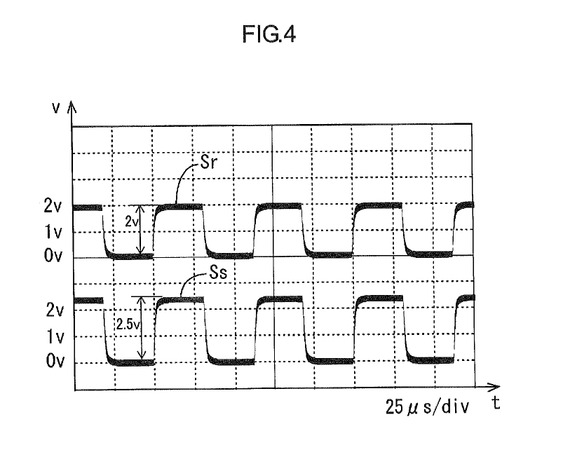

Next, communication from one of the battery cell monitors CS to another one of the battery cell monitors CS, i.e., communication between the battery cell monitors, will be explained with reference to FIG. 2 to FIG. 4. FIG. 2 schematically illustrates a communication path between the battery cell monitors, specifically, communication from the battery cell monitor CS1 to the other battery cell monitors CS2 to CS4. FIG. 3 illustrates an equivalent circuit thereof. FIG. 4 is a graph indicating examples of waveforms of a transmission signal Ss and a received signal Sr.

As indicated by arrows in FIG. 2, in the communication from the battery cell monitor CS1 to the other battery cell monitors CS2 to CS4, the communication signal (transmission signal) Ss is output from the microcomputer 12 and the transmitter 14, which configure a signal generator of the battery cell monitor CS1, and then sent to the common communication line 30 through the coupling capacitor Cc1. The transmission signal Ss is transmitted from the common communication line 30 to each coupling capacitor Cc2 to Cc4 of the respective battery cell monitors Cs2 to Cs4, and then detected by each sense resistor Rd2 to Rd4. Then, the transmission signal Ss is supplied to each microcomputer 12 through the respective receiver 13. As indicated by the arrows in FIG. 2, the transmission signal Ss supplied to the battery cell monitors CS2 to CS4 is returned to the signal generators 12, 14 of the battery cell monitor CS1 through each feedback line 16, the charge-discharge path Lba, and the feedback line 16 of the battery cell monitor CS1. The transmission signal Ss is also supplied to the sense resistor Rd1 and detected by the microcomputer 12 and the receiver 13, which configure a signal detector.

Next, each impedance condition will be explained with reference to FIG. 3. The impedance condition is set such that the communication signal detected by the sense resistor Rd has a magnitude that is substantially the same as a magnitude of the signal source to improve communication reliability.

Here, the voltage of the signal source is indicated as Vs, the impedance of the battery module is indicated as Zmod (Zmod1 to Zmod4), the impedance of the coupling capacitor is indicated as Zcc (Zcc1 to Zcc4), the impedance of the termination capacitor is indicated as Zct (Zct1, Zct2), and the impedance of the sense resistor Rd is indicated as Zrd.

Ideally, the voltage Vs of the signal source is equal to a voltage Vrd detected by the sense resistor Rd. The detected voltage Vrd is a divided voltage based on the impedance Zcc and the impedance Zrd. The smaller the impedance Zcc is, the larger the detected voltage Vrd is. Accordingly, the following expression may be satisfied.

Zcc<Zrd Expression 1

Further, as illustrated in FIG. 3, the voltage Vct applied to the termination capacitor Ct satisfies the following expression: Vct=Vcc+Vrd+Vzmod. If the impedance Zmod is small, the voltage Vct may substantially satisfy the following expression: Vct=Vcc+Vrd. Then, the equation: Vs=Vct1+Vcc1 is derived from this. If Vct1 requires a large voltage, the condition expressed by the following expression 2 is required to be satisfied.

Zcc<Zct Expression 2

Further, Zmod is required to be smaller than Zcc+Zrd to have a larger detected voltage Vrd, and thus the condition expressed by the following expression 3 is required to be satisfied.

Zmod<Zcc+Zrd Expression 3

Further, as illustrated in FIG. 3, if Zct1 is small, the following expression may be satisfied: VZmod4≈Vcc4+Vrd4. Since Vzmod4 is usually small, Vrd4 is also small. Thus, the sense resistor Rd may not properly receive the communication signal. Accordingly, the following expression may be preferably satisfied.

Zmod<Zct Expression 4

For example, if the values are set as follows: the frequency f of the transmission signal Ss is 20 kHz, the resistance value Rmod of each battery module is 10 mΩ, the capacitance cc of each coupling capacitor is 1 μF, the capacitance Ct of each termination capacitor is 0.01 μF, and the resistance value of each sense resistor is 10 kΩ, the following values are obtained: Zmod=10 mΩ, Zcc≈8Ω, Zct≈800Ω, and Zrd=10 kΩ. Accordingly, the impedance conditions of the expressions (1) to (4) are satisfied.

Preferably, the transmission signal (communication signal) Ss has an amplitude that is substantially equal to the voltage of the battery module. In this case, the transmission signal Ss having a large amplitude is obtained, and thus the transmission signal Ss has a high tolerance for noise.

The common communication line 30 and the charge-discharge path Lba constitute a loop circuit that has a wiring route longer than the wiring route between the battery cell monitor CS and the battery module Mod. Accordingly, the impedance Zct of the termination capacitor is preferably set to be as small as possible while satisfying the above relationship, so that a value of signal current flowing in the loop circuit becomes as large as possible to have high tolerance for noise.

FIG. 4 indicates a waveform of the transmission signal Ss detected by the signal detectors 12, 13 of the battery cell monitor CS1 and a waveform of the received signal Sr detected by the signal detectors 12, 13 of the battery cell monitor CS4. As illustrated in FIG. 4, the transmission signal (digital signal) Ss indicated by 0V (L level) and 2.5V (H level) becomes the receiving signal (digital signal) Sr indicated by 0V (L level) and 2.0V (H level). The communication between the battery cell monitor CS1 and the battery cell monitor CS4 is confirmed.

### 4. Effects of the Present Embodiment

As described above, the present embodiment includes the common communication line 30 connected in parallel with the charge-discharge path Lba, which is configured by the battery power Ba, the first termination capacitor Ct1, and the second termination capacitor Ct2. Accordingly, the communication between the battery cell monitors CS1 to CS4 and the communication between each of the battery cell monitors CS1 to CS4 and the battery management unit 20 can be established by simply using the common communication line 30 and the charge-discharge path Lba. That is, only a single common communication line 30 is required for communication.

Accordingly, the configuration for communication between the battery cell monitors CS1 to CS4 and the configuration for communication between each of the battery cell monitors CS1 to CS4 and the battery management unit 20 are more simplified than the configuration including a plurality of transmit-receive paths each connecting each of the battery cell monitors to the battery management unit. For example, the number of communication lines can be reduced. In addition, although a conventional battery system requires insulation elements for transmitting and receiving in each battery cell monitor, the present embodiment does not require insulation elements for transmitting and receiving in each battery cell monitor CS1 to CS4. In the conventional battery system that includes the insulation elements, a communication circuit is required to be provided between the insulation elements and the battery management unit 20 in the electrical connection. Thus, the conventional battery system requires another power circuit for the communication circuit. However, the present embodiment does not require such a power circuit. Accordingly, the production cost for the battery system 100 can be reduced. That is, according to the present embodiment, various types of communication can be established in the battery system 100 with a simple configuration and the reduced number of communication lines.

The common communication line 30 used in the above-described configuration is not required to satisfy an insulation standard, and thus the common communication line 30 does not need to have a high pressure resistance in accordance with the insulation standard. Accordingly, the termination capacitors Ct1, Ct2 and the coupling capacitors Cc0 to Cc4 each only need to have a pressure resistance that can withstand the voltage of the battery power Ba (a total voltage of the battery modules Mod1 to Mod4). Accordingly, a wider variety of components can be used for the capacitors Ct1, Ct2, and Cc0 to Cc4. This offers a greater flexibility to the circuit design.

### Other Embodiments

The present invention is not limited to the embodiment described in the above description with reference to the drawings. The following embodiments may be included in the technical scope of this invention.

(1) The common communication line (communication path) 30 in the above embodiment may be connected to a chassis ground of a vehicle. In such a case, the termination capacitors Ct1, Ct2 and the coupling capacitors Cc0 to Cc4 each need to have an insulation withstand voltage that satisfies the insulation standard.

(2) In the above embodiment, the battery system 100 includes the battery management unit 20, but the present invention is not limited thereto. The battery system 100 may not include the battery management unit 20.

(3) Instead of the coupling capacitors Cc0 to Cc4, transformers may be used.

1. An electric storage device system comprising:
an electric storage device module including at least one electric storage device;
a communication path;
a capacitor connected to the electric storage device module at one end thereof and connected to the communication path at another end thereof; and
an electric storage device monitor, wherein
the capacitor and at least apart of the electric storage device module configure a current path, and
the electric storage device monitor is configured to communicate by using the communication path and the current path.

2. The electric storage device system according to claim 1, further comprising an electric storage device management unit configured to manage the electric storage device monitor by using the communication path and the current path.

3. The electric storage device system according to claim 1, wherein
the electric storage device monitor includes a coupling capacitor connected to the communication path, and
each of the coupling capacitor and the capacitor has a capacitance that satisfies a following relationship:
Zcc<Zct and Zmod<Zct
where
Zmod, Zcc, and Zct indicate impedance of the electric storage device module, impedance of the coupling capacitor, and impedance of the capacitor, respectively, at a frequency of a communication signal transmitted through the communication path and the current path.

4. The electric storage device system according to claim 1, wherein a communication signal transmitted through the communication path and the current path is set to have an amplitude substantially equal to a voltage of the electric storage device module.

5. A communication method in an electric storage device system, the electric storage device system including an electric storage device module and an electric storage device monitor configured to monitor the electric storage device module, the electric storage device module including at least one electric storage device and configuring a current path, the communication method including:
providing a capacitor so as to be connected to the electric storage device module at one end thereof;
providing a communication path so as to be connected to another end of the capacitor; and
connecting the electric storage device monitor to the communication path, wherein
the electric storage device monitor is configured to communicate by using the communication path and the current path.

6. The communication method in the electric storage device system according to claim 5, wherein
the electric storage device system further includes an electric storage device management unit, and
the electric storage device management unit is configured to manage the electric storage device by using the communication path and the current path.

7. The communication method in the electric storage device system according to claim 5, wherein
the electric storage device monitor further includes a coupling capacitor, the coupling capacitor being connected to the communication path, and
each of the coupling capacitor and the capacitor has a capacitance that satisfies a following relationship:
Zcc<Zct and Zmod<Zct
where
Zmod, Zcc, and Zct indicate impedance of the electric storage device module, impedance of the coupling capacitor, and impedance of the capacitor, respectively, at a frequency of a communication signal transmitted through the communication path and the current path.

8. The communication method in the electric storage device system according to claim 5, further comprising setting an amplitude of a communication signal transmitted through the communication path and the current path so as to be substantially equal to a voltage of the electric storage device module.
